(19) United States
(12) Patent Application Publication
(10) Pub. No.: US 2018/0213742 A1
(43) Pub. Date: Aug. 2, 2018

(54) METHOD AND DEVICE FOR AUTOMATICALLY PLACING TEAT CUPS ONTO TEATS OF A MILK-PRODUCING ANIMAL

(71) Applicant: GEA Farm Technologies GmbH, Bönen (DE)

(72) Inventors: Jarek Jagodzinski, Gelsenkirchen (DE); Magnus Wiethoff, Welver-Dinker (DE); Clemens Renner, Dortmund (DE)

(21) Appl. No.: 15/747,541

(22) PCT Filed: Jul. 14, 2016
(86) PCT No.: PCT/EP2016/066751

§ 371 Date: Jan. 25, 2018

(30) Foreign Application Priority Data
Jul. 28, 2015 (DE) 10 2015 112 308.8

(51) Int. Cl. A01J 5/017

(52) U.S. Cl. CPC A01J 5/0175

(57) ABSTRACT

The invention relates to a method for automatically placing teat cups (7) onto teats of a milk-producing animal, in particular a cow, comprising the following steps: producing a two-dimensional image of teats of the animal, wherein distance information is present for at least a plurality of pixels of the two-dimensional image; evaluating the two-dimensional image and the distance information and establishing at least one position of at least one of the teats in a predetermined coordinate system; determining a further position of further one of the teats on the basis of the at least one previously ascertained position using the stored relative position information relating to a relative position of the teats of the animal in relation to one another; and applying one of the teat cups (7) to the further teat using the further position. The invention further relates to a device for automatically placing teat cups (7) onto teats of a milk-producing animal, in particular a cow, comprising a present process controller configured to carry out such a method, said process controller evaluating the information from the sensor and actuating the placement device.

### CROSS REFERENCE TO RELATED APPLICATIONS

This application is a national phase application under 35 U.S.C. § 371 of PCT International Application No. PCT/EP2016/066751, filed Jul. 14, 2016, which claims priority to German Application No. 10 2015 112 308.8 filed Jul. 28, 2015, the disclosures of which are incorporated by reference herein.

### FIELD AND BACKGROUND OF THE INVENTION

The invention relates to a method for automatically placing teat cups onto teats of a milk-producing animal, in particular a cow, in which a two-dimensional (2D) image of the teats of the animal is created, wherein distance information is established for at least a plurality of image points of the 2D image and wherein the position of at least one of the teats is determined on the basis of an evaluation of the 2D image taking into consideration the distance information in a specified coordinate system. The invention furthermore relates to a device for automatically placing teat cups onto teats of a milk-producing animal, in particular a cow.

In automated milking systems for milk-producing animals, for example for cows, the determination of the position of the teats or of the teat ends of the animals is of critical importance. Only if the position can be captured with sufficient spatial and time resolution is it possible for a placement operation to be performed in an automated, quick and reliable manner and consequently without subjecting the animal to stress. Three-dimensional (3D) information relating to the position of the teats in space in a specified coordinate system is required for the placement operation. In practice, various systems have become established for determining the position of the teats in space. Among them are, in particular, imaging methods in which an image having a multiplicity of image points (pixels) is established which is initially two-dimensional and is supplemented for all or at least some of the image points with distance information. The distance information relates, for example, to the distance between an image-recording camera and the object that is respectively reproduced by an image point.

Customary for obtaining the distance information are, for example, stereoscopic methods in which the distance information is obtained from a comparison of two images recorded from different directions. Another method, known from document WO 2007/104 124 A1, is the use of an imaging time-of-flight (TOF) method in which only one camera is used not only to two-dimensionally image the teats, but also to make it possible to obtain distance information for each of the pixels.

On the basis of the information relating to the position of the teats in space, a device for placing the teat cups onto the teats can be actuated. In practice, robot arms are commonly used for this purpose which either grip individual teat cups and place them onto the teats using the position information or which move a complete milking cluster having a plurality of teat cups, with the teat cups being capable of being selectively raised so as to be able to be placed one after the other. In milking parlors in which milking is automated, an attempt is made to bring the animal into a position that is reproducible, if possible, before it is milked. However, a difficulty arises during automated milking in that the position of the teats, just as the orientation of the udder itself, in the same animal differs considerably from one milking operation to another. The differences are due e.g. to different postures of the animal. In addition, the size of the udder and thus the positions of the teats are also subject to daily and seasonal changes.

Moreover, the placement operation is made more difficult because, depending on the posture and bearing of the animal, not all teats may be visible at any one point in time. This delays the placement operation until, due to another movement of the animal, each of the teats is within the field of view of the imaging camera for a sufficient time period. However, a delay or even interruption of the milking operation followed by a new placement attempt mean additional strain on and irritation to the milk-producing animal.

### SUMMARY OF THE INVENTION

It is therefore an object of the present invention to provide a method for automated placement of teat cups onto teats of a milk-producing animal, in which a placement operation can be performed successfully and as quickly as possible even if not all the teats of the milk-producing animal can be captured at any one point in time by the imaging camera. It is a further object to specify a device for performing said method.

A method according to the invention of the type mentioned in the introductory part has the following steps:

A first position of at least one of the teats in the specified coordinate system is ascertained on the basis of a 2D image of the teats and of associated distance information. A further position of a further one of the teats is determined on the basis of the at least one ascertained position using relative position information of the teats with respect to one another, whereupon placement of the teat cup at the further position takes place.

By using stored relative position information comprising the positions of individual teats of the animal relative to one another, it is possible to calculate the position of a teat that cannot be determined directly from the 2D image and the distance information from the directly determinable positions of at least one visible teat. In this way, placement of a teat cup is possible even if the relevant further teat on which placement is to be performed is not, or only partially, in the field of view of the camera.

The method can also be used if the teat on which placement is to be performed is only partially obscured. Typically, a larger number of possible teat positions is ascertained from the 2D image of the camera than teats that are actually present in the animal. In such a case, typically the number of possible positions having the highest significance level in the position determination that corresponds to the number of the teats of the animal is selected. Here, additional information relating to obscured teats can complementarily be taken into consideration.

From the 2D image and the distance information, it is possible that under certain circumstances a possible position for a partially obscured teat is ascertained which however shows no great significance level and would not typically be selected as a teat position. If, during the position determination position determination according to the invention by way of including relative position information, one of the possible positions is close to the calculated position, it is correspondingly optionally possible for the calculated position, for the possible position that is close, or for an average value of both to be used as the position for the further placement operation.

The stored relative position information can preferably be ascertained on the basis of previously created 2D images and distance information of the relevant teats, in particular from such 2D images in which all teats are visible and their positions can be correctly determined uniquely or with a high probability.

Provision may be made for the stored relative position information to be updated on the basis of at least one 2D image with distance information if the relative positions of at least two of the teats relative to one another are determinable from the relevant 2D image including the distance information.

Provision may be made for the stored relative position information with respect to the at least two teats for which current position information is available to be overwritten with the new position information. Provision may alternatively be made for stored relative position information and new position information to be offset against one another. This then results in modified stored position information that, in accordance with a specified calculation rule, is composed both of the previously stored relative position information and of the current relative position information. A weighting factor that describes the influence of current relative position information on the stored relative position information can be specified here. A possible calculation rule is, for example, an average value formation that takes into consideration any specified weighting factor.

In one advantageous configuration of the method, the 2D image is created using a TOF sensor having a plurality of image points (pixels), wherein for each of the image points distance information is ascertained in a phase detection method. The sensor is preferably a two-dimensional field (array) of image points, e.g. a CMOS (complementary metal-oxide semiconductor) sensor.

In a TOF sensor, a modulated light source for illuminating the objects in the field of view of the TOF sensor is used. The TOF sensor provides a 2D image of its field of view and in this sense acts as a camera. In addition, phase information of the captured light is evaluated with respect to the modulation of the light source for each individual image point of the sensor. Phase differences in the individual pixels are due to different times of flight of the light that is reflected by the objects in the field of view of the sensor onto the latter. It is possible to determine from the phase information a distance of the objects or object sections imaged by the individual image points from the sensor. A 2D image with depth information, i.e. a 3D image, is thus obtained. A high temporal resolution of the 3D image is advantageously achievable here.

In a further advantageous configuration of the method, at least one teat cup to be placed is also captured by the 2D image of the teats of the animal and a position of the teat cup is extracted. Placement of the teat cup onto one of the teats is effected taking into consideration an ascertained position of the teat in the specified coordinate system and the ascertained position of said teat cup in the same coordinate system. The coordinate system can here be defined for example by the position of the camera. Alternatively, the specified coordinate system can be converted on the basis of the position of one of the teats or of said teat cup such that its zero point is described by the position of one of said teats and/or said teat cup.

Deviations of the ascertained positions of the teat cups can be compared with stored positions (or positions ascertained at an earlier time). A deviation can indicate damage of the milking cluster, for example caused by a kick by the milk-producing animal.

In a further advantageous configuration of the method, the relative position information for each of the teats is stored in the form of a vector, wherein the vectors indicate the relative position of the teat with respect to a specified reference point. The specified reference point can here preferably be selected to be identical to the position of one of the teats. In that case, to indicate the relative positions of a number of N teats, only a number of (N−1) vectors is necessary. Updating of stored relative position information with current relative position information can be performed in this way of storing the relative position information by way of simple mathematical vector or matrix operations.

A device according to the invention for automatically placing teat cups onto teats of a milk-producing animal, in particular a cow, includes a placement device and a sensor for capturing a two-dimensional image of the teats of the animal and distance information for at least a plurality of image points of the two-dimensional image. It is characterized in that it has a sequence control, set up to perform a method as claimed in one of the previously mentioned claims, that evaluates information from the sensor and actuates the placement device.

### BRIEF DESCRIPTION OF THE DRAWINGS

The invention will be explained in more detail below on the basis of an exemplary embodiment with reference to figures, in which:

FIG. 1 shows a schematic perspective illustration of a device for automated milking, and

FIG. 2 shows a flowchart of an exemplary embodiment of a method for placing teat cups onto teats of a milk-producing animal.

### DETAILED DESCRIPTION OF THE DRAWINGS

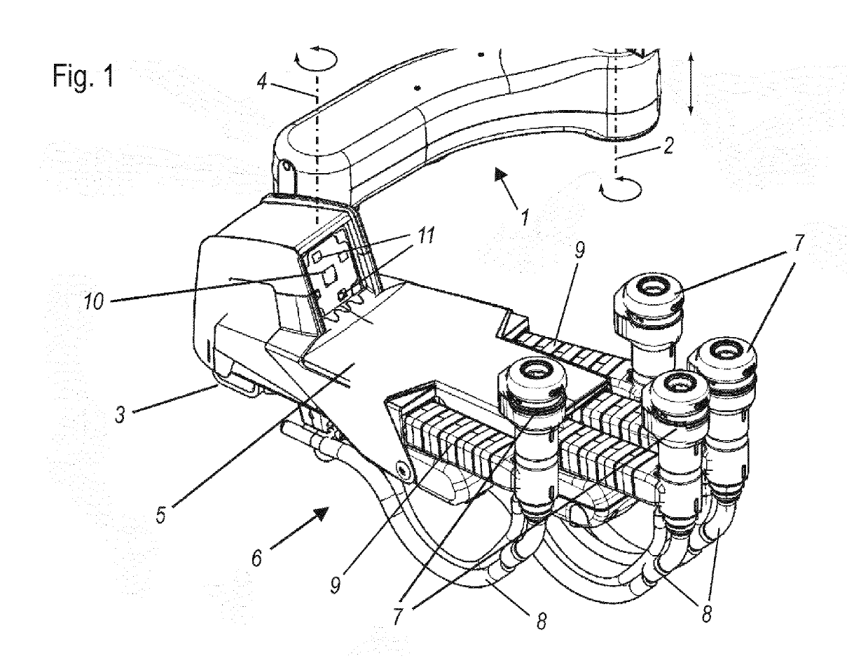

FIG. 1 shows a perspective illustration of part of a device for automated milking. The device comprises a robot arm 1, which can be displaced in the vertical direction by an arm drive unit (not illustrated here) and can be pivoted about a first pivot axis 2. Arranged at a free end of the robot arm 1 is a holder 3, which can be pivoted about a second pivot axis 4 by way of a drive unit (not illustrated here either). Mounted on the holder 3 is a milking cluster carrier 5 that carries the milking cluster 6.

In the illustrated exemplary embodiment, the milking cluster 6 comprises four teat cups 7, which are connected to a milking apparatus (not illustrated here either) by milk and vacuum tubes 8. The four teat cups 7, shown in the illustrated exemplary embodiment, serve for milking cows, for example. For other animals, for example goats or sheep, a different number of, for example two, teat cups can be provided in the milking cluster.

The teat cups 7 in the illustrated exemplary embodiment are mounted on the milking cluster carrier 5 by way of a segment element 9. The segment element 9 comprises a plurality of annular hollow segments, through which, inside the segment element 9, a pulling means, for example a rope or chain, extends that can be tensioned via an actuator. In the depiction of FIG. 1, the pulling elements of all segment elements 9 are tensioned, as a result of which all four teat cups 7 are in the illustrated raised position. The pulling means of the segment elements 9 can be actuated selectively via their actuators such that each individual one of the teat cups 7 can be brought into a raised or lowered position.

Furthermore arranged on the milking cluster carrier 5 is an imaging sensor 10 which is a TOF sensor in the present case and is correspondingly able to create a two-dimensional (2D) image with a specified number of image points (pixels), wherein in each case distance information for the distance between the image sensor 10 and the object, imaged by the respective pixels, is additionally provided for the image points. In this sense, the imaging sensor 10 can also be considered to be a 3D sensor, since it provides lateral and depth information. For this reason, the sensor 10 will also be referred to below as 3D sensor 10.

Arranged around the 3D sensor 10 are light sources 11 that serve for illuminating the field of view captured by the 3D sensor 10. The arrangement and orientation of the 3D sensor 10 are selected such that, with appropriate orientation of the milking cluster carrier 5, in principle all teats of the animal to be milked can be in the field of view of the 3D sensor 10. Aside from possible obscuration of the teats, the 3D sensor 10 thus provides information from which the position and orientation of all teats of the milk-producing animal can be ascertained at the same time. The image section is preferably also chosen such that even teat cups 7 in the raised position can be captured by the 3D sensor 10.

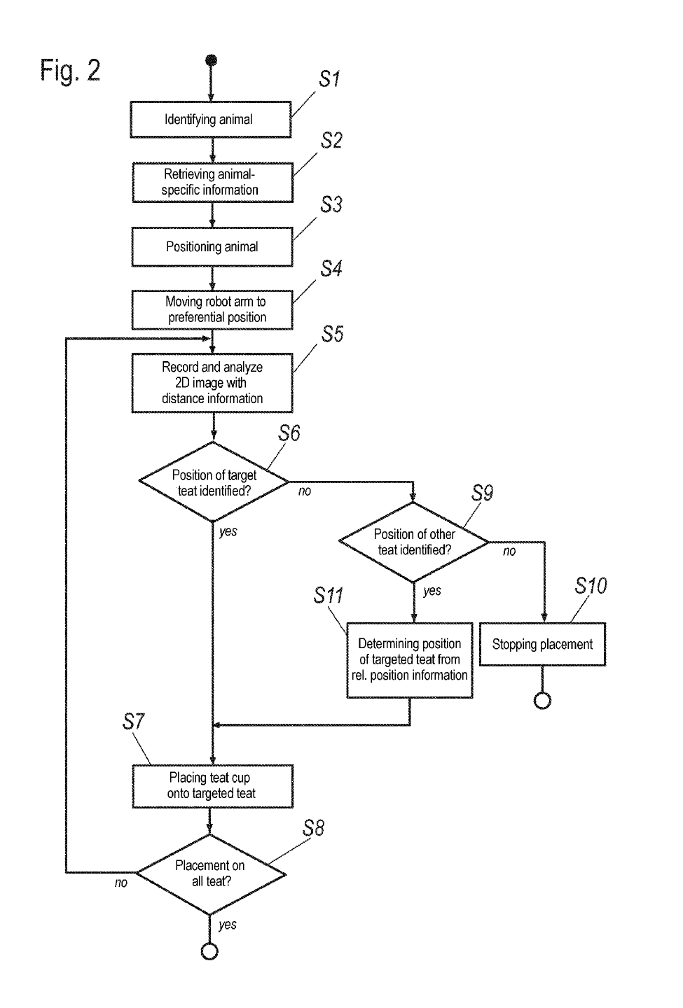

In connection with a flowchart represented in FIG. 2, a method according to the invention for automated placement of teat cups onto teats of a milk-producing animal will be explained below. The method can be performed for example using the device shown in FIG. 1 and will be explained by way of example using the reference numerals indicated in FIG. 1.

However, it is to be understood that the method according to the invention can also be performed with devices of different design. For example, the robot arm that is used to move the teat cups 7 can differ from the one illustrated in FIG. 1. For one, it is possible for a different movement sequence using differently pivotable, tiltable or displaceable arm elements to be provided. In addition, a configuration of the robot arm in which the entire milking cluster is not carried at the same time, but in which the robot arm grips and places individual teat cups is also conceivable, for example. Nor does the imaging sensor 10 necessarily have to be mounted on the robot arm or on the milking cluster carrier, but can be arranged externally and be aligned with the udder region of the milk-producing animal. Finally, it is possible to use a different technique than said TOF method for capturing the distance information in addition to the 2D imaging.

For the placement method described below, the assumption is made that a milk-producing animal enters or has entered an automated milking parlor. Upon entry or after the entry of the animal into the milking parlor, the animal is identified in a first step S1. Various methods are known for this purpose, for example the animal carries an RFID (radio frequency identification) tag that is captured in the milking parlor or upon entry into the milking parlor by a receiver, wherein an identification number of the animal is transmitted.

In a next step S2, animal-specific data is retrieved from a local or central data store on the basis of the received identification number of the animal. The animal-specific data, subsequently also referred to as animal data, includes information relating to the positioning of the animal in the milking parlor, a preferential position adopted by the robot arm, for example the robot arm 1, and the milking cluster carrier 5 as an animal-specific standard position, and relative position information of the teats of the animal with respect to one another. The various pieces of information and the meaning thereof for the present method will be explained in more detail below.

In a next step S3, the animal is positioned within the milking parlor using the received position information. This can be done, for example, by bringing a feed trough arranged in the milking parlor into a suitable longitudinal position. In other configurations of the milking parlor, provision may be made to bring, instead of the feed trough, a positioning via a bar which rests on the hindquarters of the animal and is settable with respect to its position inside the milking parlor into a suitable position. It should be pointed out that in further alternative configurations, step S3 for positioning can be omitted, for example if a device for recognizing the adopted animal position is present, which performs pre-positioning of the robot arm in subsequent method steps.

In a next step S4, the robot arm is displaced to the preferential position, which was received in step S2, under the animal to be milked.

In a next step S5, the 3D sensor 10 is used to record a first 2D image including distance information of the udder of the animal by way of the 3D sensor 10. The image is examined in terms of whether typical structures of the teats of the animal are visible. To this end, known image analysis methods can be used, for example those for edge detection. If it is not possible to identify any structures that correspond to a teat, a search method can be interposed, in which the milking cluster carrier 5 and/or the robot arm 1 is pivoted and/or tilted and/or varied in terms of its height until a structure that corresponds to the udder and to the teats lies in the field of view of the imaging sensor 10.

If teats can be identified in the 2D image, the number and the respective position of a possibly identified teat are extracted from the 2D image information and the distance information provided by the 3D sensor. If the number of structures that have been identified as possible teats exceeds the number of teats that are actually present, which may have likewise been retrieved in step S2 specific to the animal, a corresponding number of structures that have the highest probability level (significance level) of actually corresponding to a teat is selected.

In a next step S6, it is ascertained whether one of the teats on which placement is to be performed next is visible in the image of the 3D sensor 10. In the geometry of the robot arm 1 shown in FIG. 1 and the arrangement of the sensor 10, preferably first the two rear two teats are engaged, since otherwise the milking cluster placed onto the front teats will obscure the rear teats. A rear teat is one of typically two teats present in cows that are remote from the head of the animal. The two rear teats are typically located with respect to their lateral positions further inward than the front teats, which have a larger distance from one another.

If at least one suitable teat (i.e. initially one of the two rear teats) could be found in step S6, the method branches to a next step S7, in which the teat cup 7 that is assigned to the found teat is raised by actuating the corresponding actuator and is placed onto the teat. This is preferably done with continuous observation by the 3D sensor 10, wherein both the teat and the corresponding teat cup 7 are identified in the image and their positions are ascertained from the image and the distance information.

Any angled position of the teats can also be detected here and be taken into consideration in an exact determination of the position of the tips of the teats. The robot arm 1 is then actuated on the basis of the relative position of teat to teat cup 7.

In a next step S8, it is determined whether all teat cups 7 have been placed onto the number of available teats. If so, the method terminates and the milking process can begin or continue if after successful placement on one of the teats milking of the corresponding teat has already started. If not all teat cups 7 have yet been placed, the method branches from step S8 back to step S5, wherein once again an image of the teats is taken by the 3D sensor 10 and analyzed in step S6 as to whether the second of the rear teats is visible. If so, the second rear teat cup 7 is placed in step S7 and the method is repeated, wherein in that case the two teat cups that are assigned to the front teats are then to be placed one after the other.

Provision is advantageously made for placement to be performed first on the two rear teats and only then on the two front teats. Whether placement is first performed on the left one or on the right one of the rear teats, and later of the front teats, is dependent on which of the teats is more easily visible.

If during the placement on one of the two rear teats it is found that the targeted teat is not visible, for example because it is obscured by one of the front teats, the method branches from step S6 first to a step S9, instead of step S7.

In this step S9, it is ascertained whether the position of at least one, preferably of two, of the other teats can be determined. If not, the placement method must be terminated in a step S10 and possibly restarted.

If at least one, preferably one further, teat is visible, for example the two front teats during the placement on one of the rear teats, the position of the non-visible teat is calculated in a step S11 on the basis of the position of the one or the two visible teats using the stored animal-specific relevant position information. Using the calculated position, the placement method is continued in step S7, wherein in that case only the teat cup 7 is monitored in its position using current information of the 3D sensor 10 and the robot arm 1 is actuated such that the teat cup 7 with the observed position is moved to the calculated position of the non-visible teat.

The method is then continued with step S8, from where it is possibly terminated or branches back once more to step S5.

In the method discussed above, it is assumed that relative position data for the corresponding animal is already available. Provision may be made for steps S9 to S10 to be excluded until this condition is in fact met. Provision may furthermore be made in an advantageous configuration of the method for the relative position data to be updated during each placement process. To this end, in step S5 an interrogation can be performed as to whether position information is present with respect to at least two, preferably more, of the teats because the teats are identifiable at the same time in an image of the 3D sensor 10 and distance information is available. It is possible to ascertain, from position information of at least two teats, a relative position of one of the teats relative to the other. The relative position information comprises for example, in vectorial illustration, the stored relative positions of the teats with respect to one another. For example, one of the teats can be considered the reference teat and the position of the other teats relative to the former can be indicated in each case in the form of a vector with three components, with one component for each spatial direction x, y, z. If the relative position of one of the teats relative to the reference teat is currently available, this information can be used to update the stored relative positions. It may be advantageous here not to wholly adopt the current position information and overwrite the stored relative position therewith, but instead for an average value to be formed from the stored and from the current relative position and be stored as the new value. Provision may be made for the influence of the two input variables the previously stored relative position and the currently ascertained relative position not to be taken into consideration in the same way in the average value formation. It may be advantageous to this end for a weighting factor to be specified that describes the weighting of one of the two input variables.

For illustration purposes, a one-dimensional example is given below, in which it is assumed that two of the teats are at a distance from one another in only one spatial direction. The distance stored in the relative position information will be designated xₐ below. From the current evaluation of the information of the imaging sensor, a currently measured distance of xₘ is obtained. Next, an average distance value x which is to be newly stored can be given as:

x=((1−g)·xₐ+g·xₘ)/2,

wherein the weighting factor g is selected from a range of 0 to 1 and determines the magnitude of the influence of the previously stored distance value and the currently measured distance value on the distance value that is to be newly stored.

A value of g=0.5 corresponds to a regular average value formation. For a value g>0.5, the currently measured distance value has a stronger weighting, and for a value g<0.5, the stored distance value has a stronger weighting. It has been shown that a value from a range of 0.25>g>0.5 and preferably of 0.3>g>0.35 is particularly suitable. Values from the stated ranges represent a good compromise in which random fluctuations of the measurement values are not excessively weighted and in which the stored values still adapt to current measurement values with a minor time delay.

In the method illustrated in FIG. 2, the stored relative position information is used in particular for the positioning of the rear teat cups 7. However, the method can also be used to determine the position of an obscured front teat, for example on the basis of the second front teat and one of the rear teats.

1. A method for automatically placing teat cups (7) onto teats of a milk-producing animal, in particular a cow, the method comprising the steps:
creating a two-dimensional image of a plurality of teats of the animal, wherein distance information for a plurality of image points of the two-dimensional image is available;
evaluating the two-dimensional image and the distance information and ascertaining a position of a first teat in a specified coordinate system;
determining a position of a second teat on the basis of the previously ascertained first teat position using stored relative position information that relates to relative positions of teats of the animal; and
placing a teat cup onto the second teat using the determined position of the second teat.

2. The method of claim 1, wherein the first teat is a front teat with respect to an imaging sensor, and the second teat is a rear teat with respect to the imaging sensor.

3. The method of claim 1, wherein the stored relative position information is established on the basis of at least one previously created two-dimensional image and associated distance information of at least two teats.

4. The method of claim 3, and further comprising the step of:
offsetting an ascertained position and the stored relative position information against one another to change the stored relative position information.

5. The method of claim 4, wherein the step of offsetting the ascertained position and the stored relative position information comprises the step of:
forming an average value of relative positions.

6. The method of claim 5, wherein the step of forming an average value comprises the step of:
forming a weighted average of relative positions.

7. The method of claim 1, wherein the two-dimensional image is created using a time-of-flight sensor having a plurality of image points, wherein distance information is ascertained in a phase detection method for each of the image points.

8. The method of claim 1, wherein a teat cup to be placed on a teat is also captured in the two-dimensional image, and the method further comprises the step of:
ascertaining a position of the teat cup.

9. The method of claim 8, wherein the teat cup is moved considering an ascertained position of the teat in the specified coordinate system and the ascertained position of the teat cup in the same coordinate system.

10. The method of claim 1, wherein the relative position information for at least one of the teats is stored in the form of a vector, wherein the vector indicates a relative position of the teat with respect to a specified reference point.

11. The method of claim 10, wherein the specified reference point is selected to be equal to the position of one of the teats.

12. A device for automatically placing teat cups onto teats of a milk-producing animal, in particular a cow, the device comprising:
a placement device; and
a sensor for capturing a two-dimensional image of the teats of the animal and distance information for at least a plurality of image points of the two-dimensional image; and
a sequence control, set up to perform a method comprising the steps of:
creating a two-dimensional image of a plurality of teats of the animal, wherein distance information for a plurality of image points of the two-dimensional image is available;
evaluating the two-dimensional image and the distance information and ascertaining a position of a first teat in a specified coordinate system;
determining a position of a second teat on the basis of the previously ascertained first teat position using stored relative position information that relates to relative positions of teats of the animal; and
placing a teat cup onto the second teat using the determined position of the second teat.

13. The method of claim 1, wherein the stored relative position is changed on the basis of at least one previously created two-dimensional image and associated distance information of at least two teats.
